(19) United States
(12) Patent Application Publication
(10) Pub. No.: US 2005/0276665 A1
(43) Pub. Date: Dec. 15, 2005

(54) Remotely operated deployment system and method of use

(76) Inventors: Roger D. Entralgo, (US); Michael Neill Shaw, Tomball, TX (US)

Correspondence Address: DUANE, MORRIS, LLP, 3200 SOUTHWEST FREEWAY, SUITE 3150, HOUSTON, TX, 77027, US

(21) Appl. No.: 10/897,961

(22) Filed: Jul. 23, 2004

Related U.S. Application Data
(60) Provisional application No. 60/489,705, filed on Jul. 24, 2003.

(51) Int. Cl. F16L 1/028

(52) U.S. Cl. 405/190; 405/191

(57) ABSTRACT

A system and method for deploying and/or retrieving a cable underwater. In an embodiment, a system comprises a cage, comprising a guidance system adapted to be remotely operable subsea by a vessel; a communications link operatively linking the guidance system and the vessel; and a non-palletized reel rotatably and removably mounted within the cage, the reel adapted to receive an unspoolable length of cable, the cable comprising two fee ends. In an exemplary method, the reel, onto which cable is spooled is removably and rotatably housed in a cage adapted for remote control use underwater and the cage lowered by a vessel to a position proximate a seafloor. The cage is maneuvered along a predefined flight pattern in substantially a single plane with respect to the seafloor while selectively releasing the cable from the reel. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### RELATED APPLICATIONS

This application claims priority from United States Provisional Application 60/489,705 filed Jul. 24, 2003.

### FIELD OF INVENTION

The present invention relates to deployment of cables and other lines subsea.

### BACKGROUND OF THE INVENTION

Cables are often deployed underwater for numerous reasons. For example, in certain uses seismic cables may be arranged, e.g. in an array or other pattern, for use subsea. Cables for such deployment may be pre-wound on a set of reels where the reels are either on pallets underwater or on a remotely operated vehicle (ROV). Often, all cable connections are made up prior to deployment and placed upon a pallet that is delivered to the desired field of investigation. The pallets preferably include all equipment (distribution hubs, communication riser, etc.) that are needed to communicate with the cables and are delivered to the ocean floor by a crane or other lowering device with the individual sensor array cables on reels to be deployed later by the ROV. The ROV includes a reel deployer configured to pay out and apply back tension to the sensor cable.

Optionally, the ROV can include a jetting package configured to simultaneously bury the sensor cable while the cable is paid out.

Use of palletized reels and made-up connectors may complicate these systems and make them expensive to use.

Once cables are deployed, it is further often desirable to bury the cable, e.g. into the seafloor. Self-propelled sea ploughs, remotely controlled via a control flexible, may be used and may carry at least one reel of flexible conduit which the sea plough may lay and bury. The amount of cable which can be carried into place is limited in such configurations.

Often, the amount of cable to be deployed far exceeds the carrying capacity of these systems. Moreover, the systems do not allow for retrieval of cable once deployed, should that be necessary.

### BRIEF DESCRIPTION OF THE DRAWINGS

The features, aspects, and advantages of the present invention will become more fully apparent from the following description, appended claims, and accompanying drawings in which:

FIG. 1 is a plan view in partial perspective of an exemplary cage system;

FIG. 2 is a plan view in partial perspective of an exemplary cage system showing its upper and lower frames;

FIG. 3 is a plan view in partial perspective of an exemplary upper frame; and

FIG. 4 is a view illustrating an exemplary use of the cage system underwater.

### DETAILED DESCRIPTION OF A PREFERRED EMBODIMENT

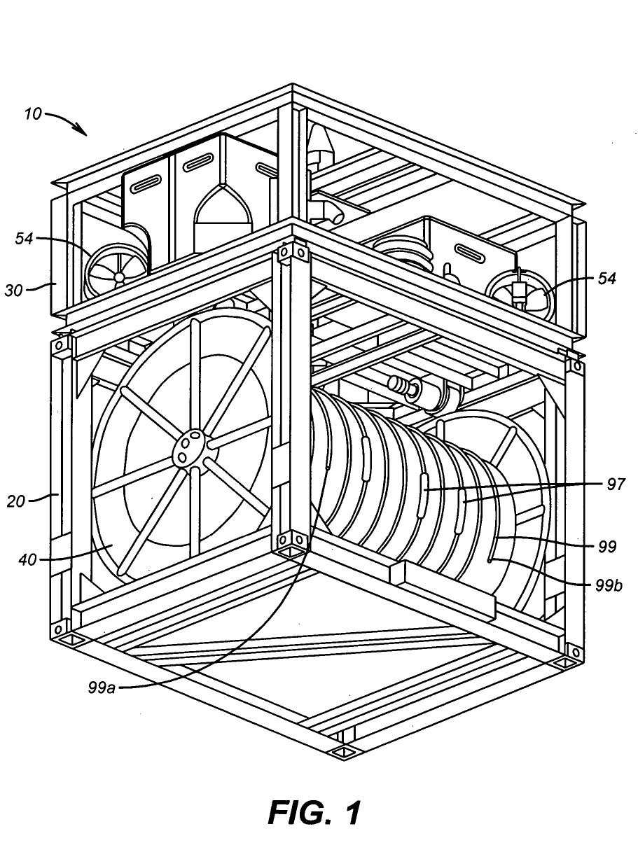

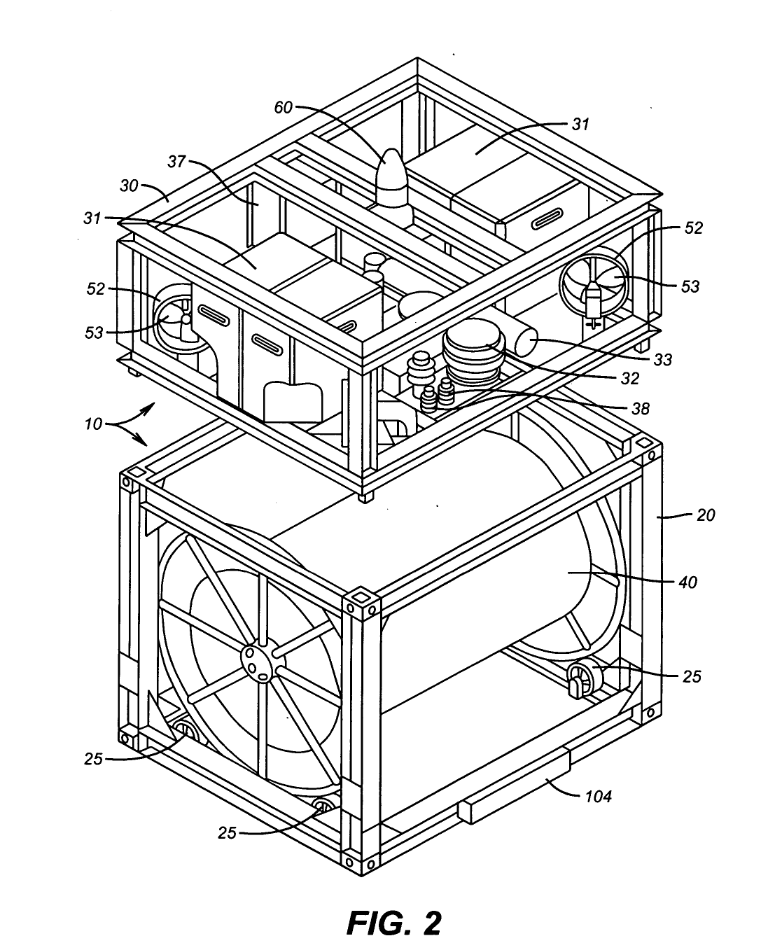

Referring now to FIG. 1 and FIG. 2, in an embodiment a remotely operated deployment system comprises cage 10, communications link 12 (not shown in the figures), and reel 40 rotatably and removably mounted within cage 10.

Cage 10 may be a unitary or multiple component unit and is typically constructed using steel welded, bolted, and/or pinned together. Cage 10 is typically around 140-160 inches in height, around 90-110 inches wide, around 110-130 inches in length, and constructed using a structural steel frame with a three pack epoxy paint coating.

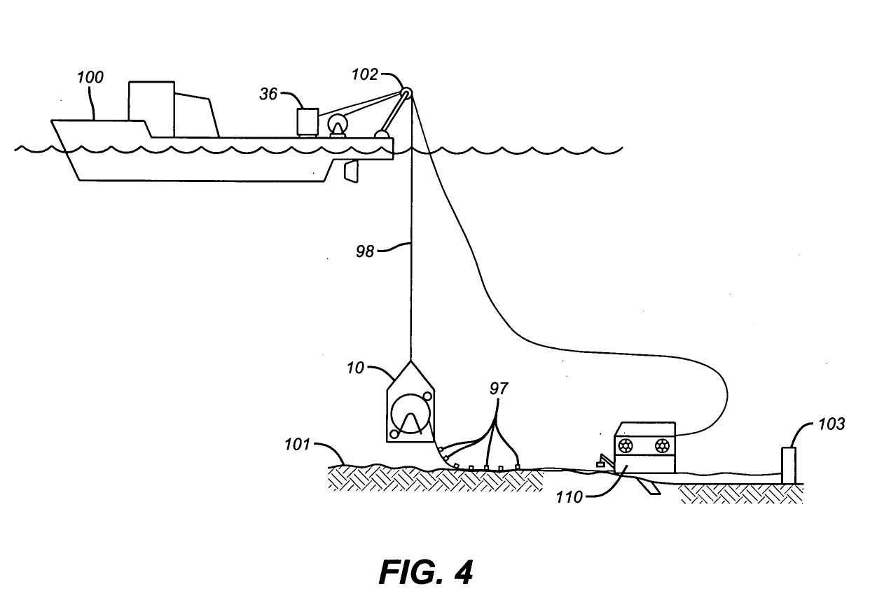

Cage 10 may further comprise guidance system 35 (not shown in the figures) adapted to be remotely operable subsea by a vessel, e.g. surface vessel 100 (FIG. 4).

Cage 10 may further comprise hydraulic power unit 33 and/or electrical power unit 37, each adapted for use underwater at a predetermined depth. In a preferred embodiment, the depth may be as much as around 10,000 feet and cage 10 may be adapted to support a load of around 15000 pounds. Although cage 10 may be used to lay flexible, spoolable cable 99 such as seismic cables susbea, the actual depth may be limited only by the length of a deployment umbilical, e.g. 98 (FIG. 4).

Block system 22 (not shown in the figures) may be disposed in lower frame 20 or cage 10 to support reel 40. Block system 22 may comprise pillow block 23 (not shown in the figures), pillow block bearing 24 (not shown in the figures), disposed proximate pillow block 23, and roller 25 (FIG. 2) disposed proximate pillow block 23. Roller 25 may be adapted to aid with positioning reel 40 with respect to pillow block 23 during a reel loading operation, e.g. on the deck of vessel 100 (FIG. 4), provide back-tension on cable 99 during an unspooling of cable 99 from reel 40, e.g. underwater, or the like, or a combination thereof.

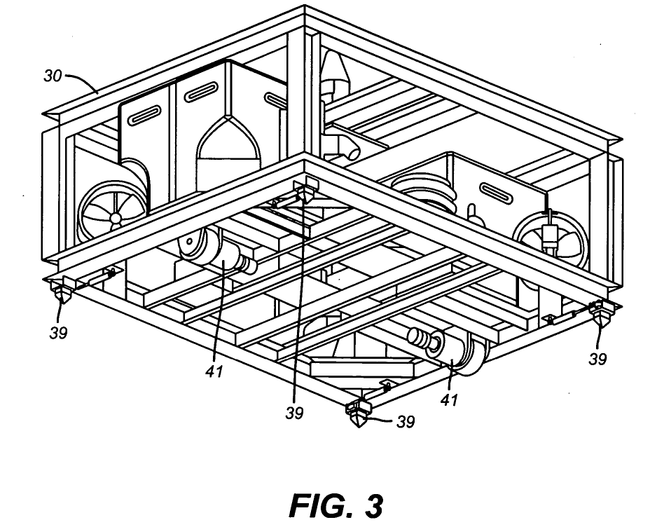

Additionally, in a preferred embodiment, a plurality of rollers 25 may be rotatably disposed within lower frame 20 and act to support reel 40 and the movement of reel 40 about its circumference. Motor system 41 (FIG. 3) may be disposed proximate reel 40, e.g. at least partially within upper frame 30, to contrably rotate reel 40 when reel 40 is in contact with rollers 25.

Reel 40 is adapted to receive an spoolable length of cable 99. Cable 99 comprises two free ends to facilitate attachment underwater, e.g. to terminator 103 (FIG. 4) or to another cable 99. As used herein, cable 99 may be a conduit, wire, chain, or other flexible, spoolable material, or the like, or a combination thereof. In certain embodiments, the flexible, spoolable material may further comprise one or more sensor units. Cable 99 does not need to be spooled under tension.

In an exemplary embodiment, cable 99 may be as long as 5 kilometers and comprise a diameter of around 21.4 mm (0.842 inches) with a minimum bend diameter of around 1500 mm (59 inches). However, cage 10 may accommodate various cables 99 having various lengths and diameters.

Cable 99 may further comprise sensor units 97, e.g. housed in metal housings, where sensor units 97 are joined together in cable 99 or to other sensor units 97 to form a continuous, flexible length. In a preferred embodiment, sensor units 97 may comprise a homogenous or heterogeneous mixture of sensor units 97.

Referring to FIG. 2, in a preferred embodiment, cage 10 further comprises lower frame 20 adapted to receive reel 40 and upper frame 30 adapted to be secured to lower frame 20. A base assembly may be used to locate reel 40 within cage 10. In a preferred embodiment, lower frame 20 may itself constrain reel 40 within lower frame 40. One or more buoyancy blocks 31, hydraulic compensators 32, and/or thrust and reel compensators 38 may be present, e.g. disposed in upper frame 30.

In certain embodiments, reel 40 may be loaded into cage 10, e.g. onto lower frame 20 using crane 102 (FIG. 4) on vessel 100 (FIG. 4). Lower frame 20 may comprise one or more movable stub axles (not shown in the figures) which, when inserted into the ends of reel 40, carry the weight of a fully loaded reel 40. A plurality of rollers 25 may be manipulated, e.g. by hydraulic rams, to assist in the loading of reel 40 and inserting of the stub axles.

Upper frame 30 may be connected to lower frame 20 by numerous equivalent means, as will be familiar to those of ordinary skill in these arts. In an embodiment, a plurality of pins, e.g. four pins 39 (FIG. 3), may be inserted, e.g. hydraulically or manually, after reel 40 has been installed in lower frame 20 to aid in securing lower frame 20 to upper frame 30.

Upper frame 30 may be adapted to aid in lifting and lowering cage 10, together with reel 40, and may further house electrical power unit 37, hydraulic power unit 33, e.g. a hydraulic pump, thrusters 52, and/or guidance system 35 (not shown in the figures), e.g. comprising a telemetry system. Termination assembly 60 located proximate the center-top of upper frame 30 may be used to mechanically connect upper frame 30 to an umbilical.

Communications link 12 (not shown in the figures) may be part of deployment umbilical 98 (FIG. 4) and may be used to operatively link guidance system 35 and vessel 100 (FIG. 4). In an embodiment, communications link may further comprise fiber optic cable to effect signal and other data transmission.

In an embodiment, reel 40 may comprise a core diameter of around 50-70 inches and have a width inside flanges of around 80-100 inches with a flange diameter of around 90-110 inches. Typical weight in air is around 1700-2600 kilograms (5600 lbs) and typical weight in water may be around 1400-2500 kilograms (4900 lbs). Reel 40 may be made of structural steel or the like and may further be coated, e.g. with epoxy such as a three pack epoxy paint. Reel 40 may be an assembly but is not palletized, either singly or jointly, e.g. with cage 10.

Guidance system 35 (not shown in the figures) may comprise one or more thrusters 52 and/or a telemetry system.

Thrusters 52 may further be disposed proximate a predefined portion of cage 10, e.g. in a corner of upper frame 30. Thruster 52 may be used to aid in moving and/or maintaining position of cage 10 during cable laying operations, e.g. be adapted to allow cage 10 to be maneuvered in a single plane relative to a seafloor (FIG. 4).

In an embodiment, there are two or more thrusters 52, each thruster 52 comprising hydraulically driven propeller 53 arranged within a cort nozzle and controlled using proportional control valve 38, which may further comprise thrust and reel compensators 38, housed inside a station valve pack. Thrusters 52 may be controlled such as by using proportional control valves 38 housed inside a mutli-valve pack. In a preferred mode, thrusters 52 are able to develop 450 kilogram-feet (992 lb-f) individually, leading to a total cage performance around 1100 kilogram-feet (2425 lb-f).

Guidance system 35 may further comprise a video system, e.g. one or more video devices such as cameras as well as high power lights, pan and tilt units for cameras, one or more compasses, one or more altimeters, and one or more depth sensors.

Guidance system 35 (not shown in the figures) may be used to decode a fiber optic signal from the umbilical. These signals may then be manipulated into control inputs for the proportional and directional valves. In reverse, data from various on-board sensors may be encoded by the telemetry can assembly and submitted to the fiber optics in the umbilical for transmission to the surface.

Hydraulic power unit 33 may comprise a subsea electric motor coupled to an pressure compensated hydraulic pump. Hydraulic power unit 33 may further comprise a 100 cc/rev variable displacement pump driven by a 100 hp motor. Hydraulic power provided by hydraulic power unit 33 may be used to energize thrusters 52 and ancillary motors. The hydraulic pump may also be used to provide pressure to the various hydraulically powered functions including thrusters 52 as well as reel braking, locking, and camera pan and tilt units.

Hydraulic proportional valve pack 38 may be used to modulate the hydraulic power of thrusters 52 and motors and control the rotational direction of thrusters 52 and motors. [0035] Electrical power may be supplied at two levels with hydraulic power unit 33 being energized at a first level, e.g. 3000 VAC 3 PH at 60 HZ, while instrumentation will run at a second level. Electrical power may be supplied via conductors in the main umbilical to the termination inside various components of cage 10.

Clumping weight 104 may be present for use during deployment of cable 99.

Other equipment may comprise sonar and a counter for rotations of reel 40.

In the operation of exemplary embodiments, referring now to FIG. 4, cable 99 may be installed underwater, e.g. subsea by deploying cable 99 onto reel 40. Reel 40 may be removably and rotatably housed in cage 10 either before or after cable 99 is spooled onto reel 40. Cage 10, with a spooled reel 40, may be lowered underwater by vessel 100 to a position proximate seafloor 101. Once lowered into position, cage 10 may be maneuvered along a predefined flight pattern in substantially a single plane with respect to seafloor 101 while selectively releasing cable 99 from reel 40. Vessel 100 substantially maneuvers cage 10 along that predefined flight pattern and may further use thrusters 52 to fine tune the movement of cage 10 in a substantially single plane, i.e. relative to seafloor 101.

Vessel controlled winch 102 may be used to effect lowering and/or retrieving of cage 30.

Vessel 100 may further retrieve cage 10, e.g. to recover an empty reel 40 from cage 10. The empty reel 40 may be replaced with another reel 40 comprising cable 99 and then the operation may resume and repeat.

Guidance system 36, located at least partially on vessel 100, may be used to at least partially control the maneuvering of cage 10 underwater and/or the selective releasing of cable 99 underwater.

In certain embodiments, cable 99 may be attached to an anchor point prior to complete unspooling of the cable. For example, the anchor point may be a weighted clump weight, a hub system, a cable backbone connected to a platform, another cable 99, or the like, or a combination thereof, e.g. 103 in FIG. 4. The anchor point may also be used to apply tension as cable 99 is deployed.

In other contemplated embodiments, ROV 110 may be used to track and bury cable 99 once deployed, e.g. upon completion of releasing cable 99 from reel 40, or during deployment.

In a further use, cable 99 already disposed underwater may be located and at least a portion of cable 99 attached to reel 40, e.g. using ROV 110 or other appropriate method of attachment. A length of cable 99 may then be spooled onto reel 40 and cage 10 retrieved to vessel 100.

It will be understood that various changes in the details, materials, and arrangements of the parts which have been described and illustrated above in order to explain the nature of this invention may be made by those skilled in the art without departing from the principle and scope of the invention as recited in the appended claims.

1. A remotely operated deployment system, comprising:
a. a cage, comprising a guidance system adapted to be remotely operable subsea by a vessel;
b. a communications link operatively linking the guidance system and the vessel; and
c. a reel rotatably and removably mounted within the cage, the reel adapted to receive an unspoolable length of cable, the cable comprising two free ends.

2. The remotely operated deployment system of claim 1, wherein the cage further comprises at least one of (i) a hydraulic power unit or (ii) an electrical power unit.

3. The remotely operated deployment system of claim 1, wherein the cage further comprises:
a. a lower frame adapted to receive the reel; and
b. an upper frame adapted to be secured to the lower frame.

4. The remotely operated deployment system of claim 3, further comprising:
a. a roller disposed within the lower frame proximate the reel; and
b. a reel driver disposed within the upper frame proximate the reel and adapted to controllably rotate the reel.

5. The remotely operated deployment system of claim 1, wherein the guidance system comprises at least one of (i) a thruster or (ii) a telemetry system.

6. The remotely operated deployment system of claim 5, wherein the telemetry system further comprises a video system.

7. The remotely operated deployment system of claim 5, wherein the thruster comprises a plurality of thrusters, each disposed proximate a predefined portion of the cage.

8. The remotely operated deployment system of claim 5, wherein the thruster comprises a hydraulically driven propeller arranged within a cort nozzle and controlled using a proportional control valve housed inside a station valve pack.

9. The remotely operated deployment system of claim 1, wherein the vessel is a surface vessel.

10. The remotely operated deployment system of claim 1, wherein the cage is adapted to support a load of around 15000 pounds.

11. The remotely operated deployment system of claim 1, wherein the cable comprises at least one of (i) conduit, (ii) wire, (iii) a chain, (iv) a flexible, spoolable material, or (v) a flexible, spoolable material comprising a sensor unit.

12. A method of installing a cable subsea, comprising:
a. deploying a cable onto a reel;
b. removably and rotatably housing the reel in a cage adapted for remote control use underwater;
c. lowering the cage by a vessel to a position proximate a seafloor; and
d. maneuvering the cage along a predefined flight pattern in substantially a single plane with respect to the seafloor while selectively releasing the cable from the reel.

13. The method of claim 12, further comprising:
a. retrieving the cage by the vessel;
b. recovering the empty reel from the cage;
c. replacing the empty reel with another reel comprising cable.

14. The method of claim 13, further comprising using a vessel controlled winch to effect at least one of (i) the lowering of the cage or (ii) the retrieving of the cage.

15. The method of claim 12, further comprising using a guidance system on the vessel to at least partially control at least one of (i) the maneuvering of the cage underwater or (ii) the selective releasing of the cable.

16. The method of claim 12, further comprising attaching the cable to an anchor point prior to complete unspooling of the cable, the anchor point comprising at least one of (i) a weighted clump weight, (ii) a HUB system, or (iii) cable backbone connected to a platform.

17. The method of claim 16, further comprising using the anchor point to apply tension as the cable is deployed.

18. The method of claim 12, further comprising using an ROV to track and bury the cable after the cable is at least partially unspooled.

19. The method of claim 18, wherein the ROV is used to track and bury the cable upon completion of unspooling the cable from the reel.

20. A method of retrieving a cable subsea, comprising:
a. locating a cable deployed underwater;
b. attaching at least a portion of the cable to a reel removably and rotatably housed in a cage adapted for remote control use underwater;
c. spooling a length of cable onto the reel; and
d. retrieving the cage to a vessel.

21. The method of claim 20, further comprising maneuvering the cage along a predefined flight pattern in substantially a single plane with respect to the seafloor while spooling the length of cable onto the reel.
